(19) United States
(12) Patent Application Publication
(10) Pub. No.: US 2015/0292688 A1
(43) Pub. Date: Oct. 15, 2015

(54) Lighting Assembly and Method

(71) Applicant: KENALL MANUFACTURING COMPANY, Gurnee, IL (US)

(72) Inventor: Kevin Dahlen, Lindenhurst, IL (US)

(73) Assignee: KENALL MANUFACTURING COMPANY, Gurnee, IL (US)

(21) Appl. No.: 14/250,645

(22) Filed: Apr. 11, 2014

(51) Int. Cl. F21K 99/00; F21V 5/04; F21V 17/06; F21V 3/04

(52) U.S. Cl. CPC F21K 9/58; F21K 9/17; F21V 3/04; F21V 5/04; F21V 17/06; F21Y 2103/003

(57) ABSTRACT

A lighting assembly comprises a base having a pair of sides and at least one light source coupled to the base, the at least one light source having a longitudinal axis. A diffuser cover is removably secured to the base and has an inside surface and an outside surface, the inside surface defining a volume in which the at least one light source is disposed. A substrate is disposed along an inside surface of the diffuser cover, such that each ray of light emitted from the at least one light source contacts the substrate. Upon contact with the substrate, diffusion of the at least one ray of light emitted from the at least one light source is increased, creating a wider distribution of light about the outside surface of the diffuser cover.

### FIELD OF THE DISCLOSURE

This disclosure relates generally to lighting assemblies, and, more particularly, to diffusers for lighting assemblies.

### BACKGROUND

Suspended or ceiling-mounted lighting fixtures are typically used in large-volume structures having high ceilings, e.g., commercial, industrial, or warehouse structures to provide lighting over a wide area. Such lighting fixtures or luminaries may include a lighting element and a lens or reflector to direct the light emitted from the lighting element to desired areas.

While conventional incandescent bulbs are often used in large-volume, high-ceiling structures, such bulbs have several drawbacks. Specifically, incandescent bulbs have relatively low energy efficiency, relatively low power input, and a relatively short useful life. Because bulbs are difficult to replace in large volume structures, and because maximizing energy efficiency is desired when large areas are illuminated, downwardly-directed light emitting diodes (LEDs) are often used in the lighting element. While the light is downwardly-directed from the LEDs, the light is often not laterally or upwardly-directed outside of the lighting element, which compromises the lighting effectiveness. In addition, individual LEDs within each lighting element are often still visible during use and create a glaring effect.

### BRIEF SUMMARY OF THE DISCLOSURE

In accordance with one exemplary aspect of the present disclosure, a lighting assembly comprises a base having a pair of sides and at least one light source coupled to the base. The at least one light source has a longitudinal axis, wherein the at least one light source is adapted to illuminate. A diffuser cover is removably secured to the base and has an inside surface and an outside surface, the inside surface defining a volume in which the at least one light source is disposed. A substrate is disposed along the inside surface of the diffuser cover, such that each ray of light emitted from at least one light source contacts the substrate. The substrate increases diffusion of the at least one ray of light emitted from the at least one source, creating a wider distribution of light about the outside surface of the diffuser cover and reducing glare.

In accordance with another exemplary aspect of the present disclosure, a lighting assembly comprises a base having a pair of sides and at least one light source coupled to the base. The at least one light source has a longitudinal axis and is adapted to illuminate. A diffuser cover is removably secured to the base and has an inside surface and an outside surface. A substrate is attached to the base and includes an inner surface and an outer surface. The substrate forms a first volume between the inner surface of the substrate and the base and a second volume between the outer surface of the substrate and the diffuser cover, wherein the at least one light source is disposed within the first volume. Diffusion of at least one ray of light emitted from the at least one source is first increased upon contact with the inner surface of the substrate and again increased upon contact with the diffuser cover. This creates a wider distribution of light around the outside surface of the diffuser cover and reduces glare.

According to yet another aspect of the present disclosure, a method of diffusing light from a lighting assembly comprises removably securing a diffuser cover to a base having at least one light source coupled thereto, the diffuser cover having an inside surface and an outside surface, and attaching a substrate to one or more of the base or the inside surface of the diffuser cover. The method further comprises directing at least one ray of light emitted from the at least one light source into contact with the substrate, causing light from the at least one light source to be widely distributed about the outside surface of the diffuser cover.

### BRIEF DESCRIPTION OF THE DRAWINGS

FIG. 1 is a side view of a lighting assembly according to one aspect of the present disclosure;

FIG. 2 is an enlarged portion of the side view of the lighting assembly of FIG. 1;

FIG. 3 is side, perspective view of the portion of the lighting assembly of FIG. 2;

FIG. 4 is a top, perspective view of the portion of the lighting assembly of FIG. 2;

FIG. 5 is a bottom, perspective view of the portion of the lighting assembly of FIG. 2;

FIG. 6 is a cross-sectional view of the lighting assembly of FIG. 1, taken along the lines B-B of FIG. 1;

FIG. 7 is a side view of another lighting system according to another aspect of the present disclosure; and

FIG. 8 is a cross-sectional view of the lighting assembly of FIG. 7, taken along the lines C-C of FIG. 7.

### DETAILED DESCRIPTION OF THE DISCLOSURE

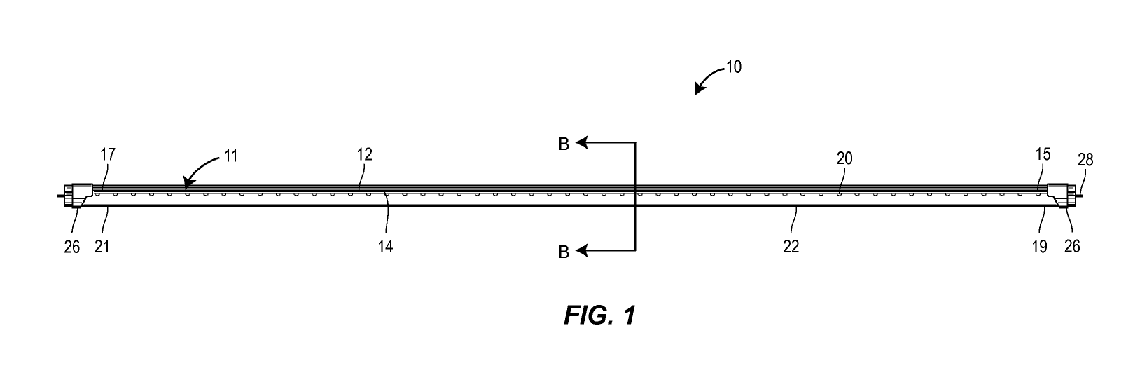

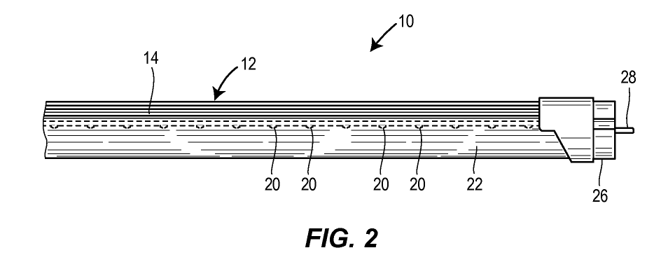

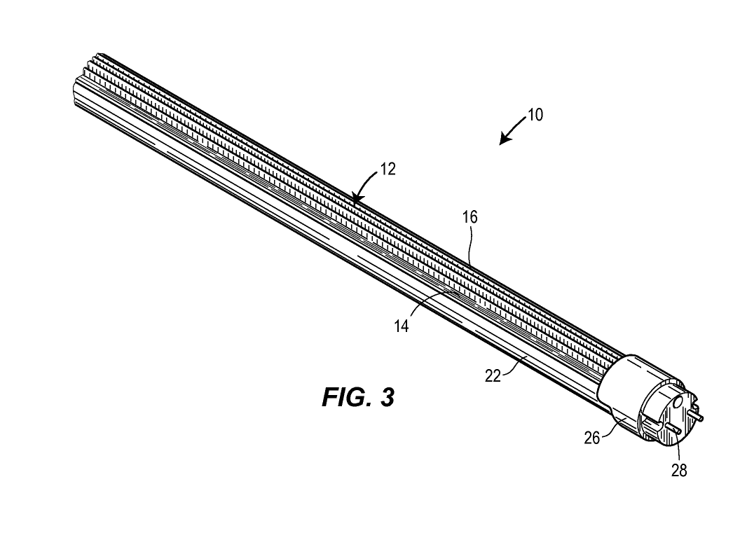

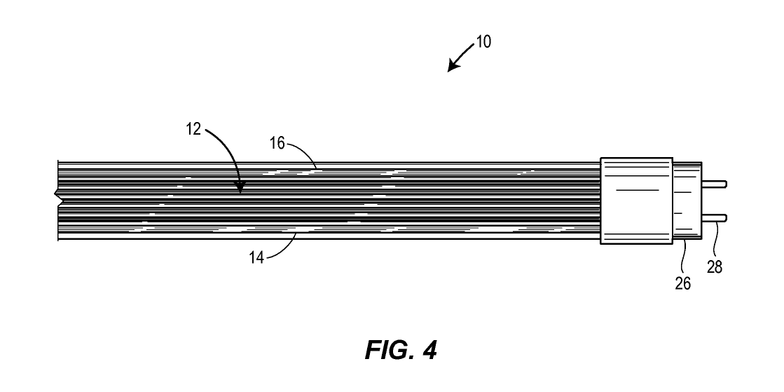

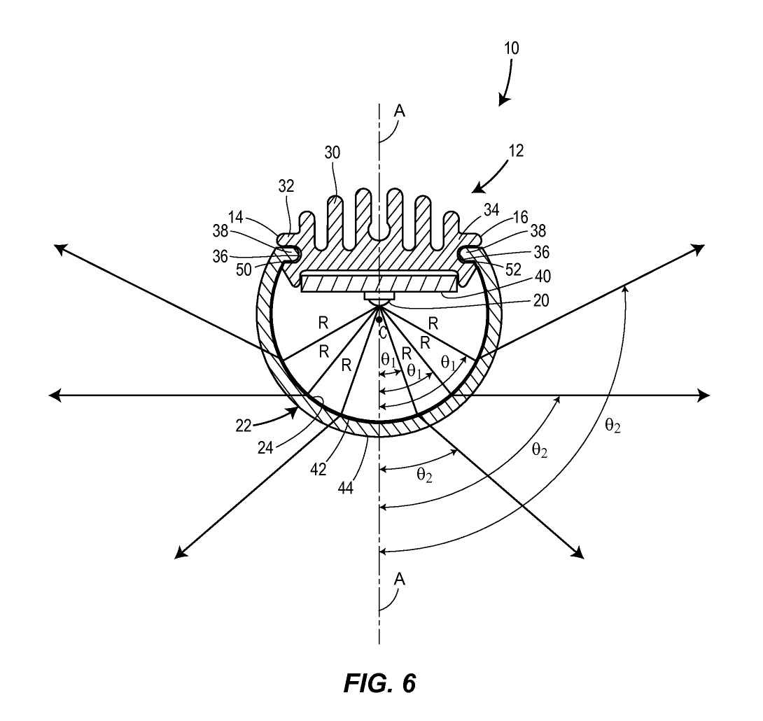

Referring now to FIGS. 1-5, a lighting assembly 10 includes a base 12 having a pair of sides 14, 16 (FIG. 3) and at least one light source 20 coupled to the base 12. The at least one light source 20 includes a longitudinal axis A (FIG. 6) and at least one ray of light R (FIG. 6), wherein the at least one light source 20 is adapted to illuminate. A diffuser cover 22 is removably secured to the base 12 and includes an inside surface and an outside surface, as explained in more detail below. The inside surface defines a volume in which the at least one light source 20 is disposed, as also explained in more detail below.

A substrate 24 (FIG. 6) is disposed along the inside surface of the diffuser cover 22, such that each at least one ray of light R emitted from the at least one light source 20 contacts the substrate 24. So configured, the substrate 24 increases diffusion of the at least one ray of light R emitted from the at least one light source 20, creating a wide distribution of light about the outside surface of the diffuser cover 22 and reducing glare. Thus, the substrate 24 creates an additional diffusion layer through which each of the at least one ray of light R from the at least one light source 20 travels. This creates more diffusion of light outside of the diffuser cover 22 and the lighting assembly 20 generally. Said another way, the substrate 24 spreads out more light emitted from each of the at least one light source 20, creating more diffusion of light outside of the diffusion cover 22 and reducing glare.

Turning to the lighting assembly 10 in more detail, and referring now to FIGS. 1-5, the lighting assembly 10 may include an elongated tube 11 that includes the base 12 and the at least one light source 20. The base 12 may include a first end 15 and a second end 17 disposed opposite the first end 15. In a similar manner, the diffuser cover 22, which is secured to the base 20, also includes a first end 19 and a second end 21. The first end 15 of the base 12 is aligned with the first end 19 of the diffuser cover, and the second end 17 of the base 12 is likewise aligned with the second end 21 of the diffuser cover when the diffuser cover 22 is secured to the base 12 to form the tube 11. In addition, the lighting assembly 10 also includes a cap 26 disposed on either end of the tube 11. The cap 26 covers portions of the ends 15, 19 of the base 12 and diffuser cover 22, respectively, at one end and portions of the ends 17, 21 of the base 12 and the diffuser cover 22 at the other end. As one of ordinary skill in the art will appreciate, the caps 26 each include an AC power input 28, for example, and provide the interface for connecting to a power source during use of the lighting assembly 10.

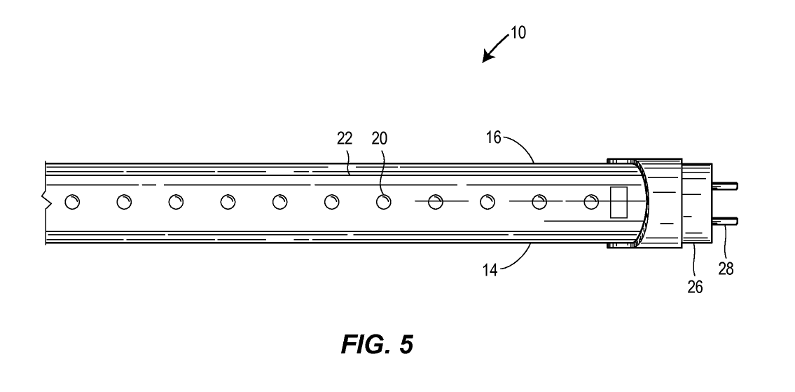

As depicted in FIGS. 1, 2 and 5, for example, the at least one light source 20 may be a light emitting diode or LED. In another example, the at least one light source 20 is a plurality of light sources, such as a plurality of LEDs arranged in an array along a length of the base 12 (FIG. 5). More specifically, the tube 11 may be a T8 LED tube that is four feet in length and includes 72 LEDs in each four foot section. Alternatively, the tube 11 of the lighting assembly 10 may be a T2, T4, T5, T6, T10, T12 LED tube or any other conventional LED tube having an LED array with various numbers of LEDs and still fall within the scope of the present disclosure.

In one example, the substrate 24 (FIG. 6) is a nano-optic film or lens comprising one or more of acrylic, polycarbonate or polymethylmethacrylate (PMMA). In another example, the substrate 24 is a lens material comprising only acrylic. In yet another example, the substrate 24 is a lens material comprising only one of polycarbonate or PMMA. In yet another example, the substrate 24 is a nano-optic film material comprising only acrylic. In still yet another example, the substrate 24 is a nano-optic film material comprising only one of polycarbonate or PMMA.

Referring now to FIG. 6, a cross-sectional view of the lighting assembly 10 of FIG. 1 taken along the lines B-B of FIG. 1 is depicted. As illustrated therein, the base 12 further includes a heat sink 30 having a pair of sides 32, 34. Each side 32, 34 includes a groove 36 adapted to receive a portion of the diffuser cover 22. More specifically, and as further illustrated in FIG. 6, the diffuser cover 22 may include a pair of inwardly extending flanges 38. Each inwardly extending flange 38 fits within a corresponding groove 36 of the heat sink 30 of the base 12 to removably secure the diffuser cover 22 to the base 12. The heat sink 30 operates in a conventional manner, e.g., to dissipate heat emanating from each of the at least one light source 30, such as LEDs, during operation of the lighting assembly 10.

As further depicted in FIG. 6, the base 12 may further include a board 40, such as a printed circuit board or an LED board, to which the at least one light source 20, such as a plurality of LEDs 22, is coupled. In one example, the board 40 is coupled to the heat sink 30. Each board 40 may include a plurality of LEDs disposed thereon. In one example, each LED board may have, for example, a capacity of 72 LEDs. Alternatively, each board 40 of the lighting assembly 10 may include an LED board that includes other amounts of LEDs, such as fewer or more LEDs disposed thereon.

As further depicted in FIG. 6, the diffuser cover 22 may further include an inside surface 42 and an outside surface 44. The substrate 24 is one or more of slid onto or disposed on the inside surface 42 of the diffuser cover 22 along the entire length of the diffuser cover 22 from the first end 19 to the second end 21. In this manner, the substrate 24 takes the shape of the diffuser cover 22. In addition, the substrate 24 in effect adds another diffuser layer to the diffuser cover 22 of the lighting assembly 10. In another example, the substrate 24 may be affixed to the inside surface 42 of the diffuser cover 22 via an adhesive or other material that secures the substrate 24 to the diffuser cover 22. In yet another example, the substrate 24 may include a first side 50 and a second side 52. As depicted in FIG. 6, the sides 50, 52 of the substrate 24 may be press-fit between the flanges 38 of the diffuser cover 22 and a portion of the base 12.

During operation of the lighting assembly 10, the at least one light source 20 emits at least one ray of light R at an acute angle θ₁ from the longitudinal axis A of the at least one light source 20 before contacting the substrate 24. More specifically, and in one example, a plurality of rays of light R are emitted from the light source 20, and each ray of light R of the plurality of rays of light R is initially emitted at an acute angle θ₁. An acute angle is an angle less than 90° from the longitudinal axis A of the at least one light source 20.

Upon contact with the substrate 24, however, each of the at least one ray of light R emitted from the at least one light source 20 is disposed at another, increased angle θ₂ from the longitudinal axis A of the at least one light source 20. The increased angle θ₂ is an angle greater than the acute angle θ₁ at which the light is emitted from the at least one light source before contacting the substrate 24. Said another way, the angle θ₁ at which the at least one ray of light R is emitted from the at least one light source 20 changes from an acute angle θ₁ to one of an obtuse angle θ₂ or an angle θ₂ greater than the previous acute angle θ₁ from the longitudinal axis A of the least one light source 20 upon contact with the substrate 24. Such change in the angle at which the light is emitted increases the diffusion of light and creates a wider distribution of light about the outside surface 44 of the diffuser cover 22. In other words, the angle θ₁ at which the at least one ray of light R is emitted from the at least one light source 20 increases for each at least one ray of light R upon contact with the substrate 24. This allows light to be directed downwardly, upwardly, and laterally from a center point C of the lighting assembly 10, and not just primarily downwardly, for example.

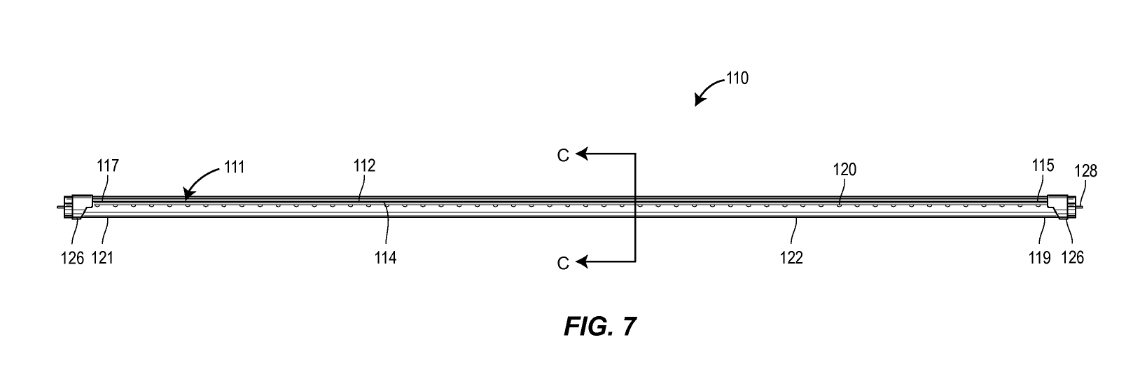

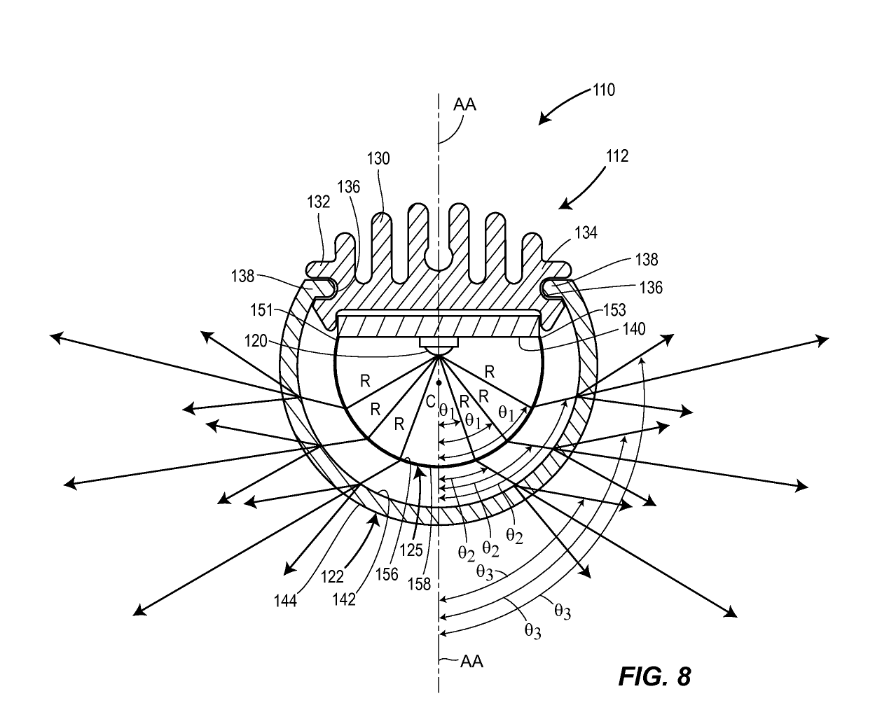

Referring now to FIGS. 7 and 8, a lighting assembly 110 according to another aspect of the present disclosure is depicted. The lighting assembly 110 includes many of the same parts as the lighting assembly 10 depicted in FIGS. 1-6. As such, for consistency, the parts of the lighting assembly 110 of FIGS. 7 and 8 that are the same as parts of the lighting assembly 10 are similarly numbered. For example, the parts of the lighting assembly 110 are numbered one hundred more, e.g., 110 instead of 10, than the same part of the lighting assembly 10.

Referring now to FIG. 7, the lighting assembly 110 includes a base 112 having a pair of sides 114, 116 (not shown) and at least one light source 120 coupled to the base 112. The at least one light source 120 includes a longitudinal axis AA (FIG. 8) and at least one ray of light R (FIG. 8), wherein the at least one light source 120 is adapted to illuminate. A diffuser cover 122 is removably secured to the base 112 and includes an inside surface and an outside surface, as explained in more detail below.

A substrate 125 (FIG. 8) is attached to the base 112 and includes an inner surface 156 and an outer surface 158, as also explained in more detail below. The substrate 125 forms a first volume between the inner surface 156 of the substrate 125 and the base 112 and a second volume between the outer surface 158 of the substrate 125 and the inside surface of the diffuser cover 122. The at least one light source 120 is disposed within the first volume.

So configured, the substrate 125 increases diffusion of the at least one ray of light R emitted from the at least one light source 120, creating a wide distribution of light about the outside surface of the diffuser cover 22 and reducing glare. More specifically, diffusion of the at least one ray of light R emitted from the at least one source is first increased upon contact with the inner surface of the substrate 125. Diffusion is then again increased upon contact with the diffuser cover 122. Thus, the substrate 125 creates an additional diffusion layer through which each of the at least one ray of light R from the at least one light source 20 travels. This creates more diffusion of light outside of the diffuser cover 122 and the lighting assembly 110 generally. Said another way, the substrate 125 spreads out more light emitted from each of the at least one light source 120, creating more diffusion of light outside of the diffusion cover 122 and reducing glare.

Turning to the lighting assembly 110 in more detail, and referring again now to FIG. 7, the lighting assembly 110 may include an elongated tube 111 that includes the base 112 and the at least one light source 120. The base 112 may include a first end 115 and a second end 117 disposed opposite the first end 115. In a similar manner, the diffuser cover 122, which is secured to the base 112, also includes a first end 119 and a second end 121. The first end 115 of the base 112 is aligned with the first end 119 of the diffuser cover and the second end 117 of the base 112 is likewise aligned with the second end 121 of the diffuser cover when the diffuser cover 122 is secured to the base 112. In addition, the lighting assembly 110 also includes a cap 126 disposed on either end of the tube 111. The cap 126 covers portions of the ends 115, 119 of the base 112 and diffuser cover 122, respectively, at one end and portions of the ends 117, 121 of the base 112 and the diffuser cover 122 at the other end. As one of ordinary skill in the art will appreciate, the caps 126 each include an AC power input 128, for example, and provide the interface for connecting to a power source during use of the lighting assembly 110.

Like the lighting assembly 10, the at least one light source 120 of the lighting assembly 110 may be a light emitting diode or LED. In another example, the at least one light source 120 is a plurality of light sources, such as a plurality of LEDs arranged in an array along a length of the base 112. More specifically, the tube 111 of the lighting assembly 110 may also be a T2, T4, T5, T6, T10, T12 LED tube or any other conventional LED tube having an LED array with various numbers of LEDs and still fall within the scope of the present disclosure.

In one example, and like the substrate 24 of the lighting assembly 10, the substrate 125 is a nano-optic film or lens comprising one or more of acrylic, polycarbonate or polymethylmethacrylate (PMMA).

Referring now to FIG. 8, a cross-sectional view of the lighting assembly 110 of FIG. 7 taken along the lines C-C of FIG. 7 is depicted. As illustrated therein, the base 112 further includes a heat sink 130 having a pair of sides 132, 134. Each side 132, 134 includes a groove 136 extending along the length of the base 112 and adapted to receive a portion of the diffuser cover 122. More specifically, and as further illustrated in FIG. 8, the diffuser cover 122 may include a pair of inwardly extending flanges 138. Each inwardly extending flange 138 fits within or slides into a corresponding groove 136 of the heat sink 130 of the base 112 to removably secure the diffuser cover 122 to the base 112. The heat sink 130 operates in a conventional manner, e.g., to dissipate the heat emanating from each of the at least one light source 130, such as LEDs, during operation of the lighting assembly 110.

As further depicted in FIG. 8, the base 112 may further include a board 140, such as a printed circuit board or an LED board, to which the at least one light source 120, such as a plurality of LEDs, is coupled. In one example, the board 140 is coupled to the heat sink 130. Each board 140 may include a plurality of LEDs.

As further depicted in FIG. 8, the diffuser cover 122 may further include an inside surface 142 and an outside surface 144. In addition, the substrate 125 includes a first side 151 and a second side 153, and the first and second sides 151, 153 are attached to the base 112 to secure the substrate 125 to the base. In one example, the first and second sides 151, 153 of the substrate 125 are press-fit between the board 140 and another portion of the base 112, such as the heat sink 130. Such a construction essentially encloses the at least one light source 120 within the first volume formed between the base 140 and substrate 125. In another example, the first and second sides 151, 153 of the substrate 125 are secured to the board 140 or another portion of the base 112 via an adhesive. As one of ordinary skill in the art will appreciate, any other securing mechanism, such as a screw, a nut, a bolt, a nail, a rivet, or any other similar structure, may alternatively be used to secure the sides 151, 153 of the substrate 125 to the base 112, such as the board 140 of the base, in one example, and still fall within the scope of the present disclosure. Securing the substrate 125 to the base 112 in this manner suspends the substrate 125 from the base 112, such that the substrate 125 is disposed between the base 112 and the diffuser cover 122.

So configured, upon contact with the inner surface 156 of the substrate 125, each ray of light R emitted from the at least one light source 120 is disposed at an angle θ₂ from the longitudinal axis AA of the at least one light source 120. This angle θ₂ is greater than an acute angle θ₁ at which the light is emitted initially from the at least one light source 120 before contacting the inner surface 156 of the substrate 125. Upon contact with the inside surface 142 of the diffuser cover 122, the at least one ray of light R disperses and at least one ray of light R is disposed at an angle θ₃ from the longitudinal axis AA of the at least one light source 120. This angle θ₃ may be greater than the angle θ₂ at which the at least one ray of light R contacts the inner surface 156 of the substrate 125. Said another way, the angle at which the at least one ray of light R is emitted from the at least one light source increases for at least one ray of light upon contact with the inner surface 156 of the substrate 125 and again upon contact with the inside surface 142 of the diffuser cover 122. This allows light to be directly downwardly, upwardly, and laterally from a center point C of the lighting assembly 110.

As depicted in FIGS. 1-8, both diffuser covers 22, 122 of the foregoing lighting assemblies 10, 110 may be generally cylindrical in shape or generally frustoconical in shape. However, the diffuser covers 22, 122 may have any suitable shape to house and/or protect, for example, the at least one light source 20, 120 and other related electrical components. For example, the diffuser covers 22, 122 may be semi-circular, rounded, triangular, rectangular, square-like, or square in shape, or any other shape not listed, and still fall within the scope of the present disclosure. Further, the substrate 24 disposed on the diffuser cover 22, as explained in detail above, may then take the shape of any of the foregoing possible listed shapes of the diffuser covers 22, 122. In addition, the diffuser cover 22, 122 may be made of any suitable material, such as acrylic or polycarbonate.

While not depicted in any of the foregoing figures, one of ordinary skill in the art will appreciate that another lighting assembly may include variations of the substrates 24, 125 of each of the lighting assemblies 10, 110 and still fall within the scope of the present disclosure. For example, another alternative lighting assembly may include both a substrate 24 disposed on the inside surface 42, 142 of the diffuser cover 22, 122 and attached to the base 12, 112. Such a configuration would even further increase diffusion of the rays of light emitted from the light source 20, 120. In another example, there may be one or more other substrates disposed between the substrate 125 attached to the base 112 (FIG. 8) and the substrate 24 disposed on the inside surface 42 of the diffuser cover 22, 122, even further increasing the diffusion of light travelling through each substrate of the lighting assembly.

In view of the foregoing, one of ordinary skill in the art will understand that both lighting assemblies 10, 110 of the present disclosure may diffuse light emitted from at least one light source 20, 120 of the lighting assembly 10, 110 by removably securing the diffuser cover 22, 122 to the base 12, 112 and attaching the substrate 24, 125 to one or more of the base 12, 112 or an inside surface 42, 142 of the diffuser cover. The lighting assemblies 10, 110 may further diffuse the light by directing the at least one ray of light R emitted from the at least one light source 20, 120 into contact with the substrate 24, 125. This causes light from the at least one light source 20, 120 to be widely distributed about the outside surface 44, 144 of the diffuser cover 22, 122.

In view of the foregoing, one of the ordinary skill in the art will further understand that both lighting systems 10, 110 of the present disclosure increase the amount of diffusion and dispersion of light about and around a larger surface area of the diffuser cover 22, 122. As a result, a greater and/or wider distribution of light surrounds the diffuser cover 22, 122 and glare is reduced. In addition, the light emitted from the at least one light source 20, 120 is directed upwardly, laterally and downwardly from a center point of the lighting assembly 10, 110, increasing the diffusion of light around the lighting assembly 10, 110.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one example” or “an example” means that a particular element, feature, structure, or characteristic described in connection with the embodiment is included in at least one embodiment. The appearances of the phrase “in one example” in various places in the specification are not necessarily all referring to the same example.

Some examples may be described using the expression “coupled” and “connected” along with their derivatives. For example, some examples may be described using the term “coupled” to indicate that two or more elements are in direct physical or electrical contact. The term “coupled,” however, may also mean that two or more elements are not in direct contact with each other, but yet still cooperate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

While various embodiments have been described above, this disclosure is not intended to be limited thereto. Variations can be made to the disclosed embodiments that are still within the scope of the appended claims.

1. A lighting assembly comprising:
a base having a pair of sides;
at least one light source coupled to the base and having a longitudinal axis, wherein the at least one light source is adapted to illuminate;
a diffuser cover removably secured to the base and having an inside surface and an outside surface, the inside surface defining a volume in which the at least one light source is disposed; and
a substrate disposed along the inside surface of the diffuser cover, such that at least one ray of light emitted from the at least one light source contacts the substrate,
the substrate increasing diffusion of at least one ray of light emitted from the at least one light source, creating a wider distribution of light about the outside surface of the diffuser cover and reducing glare.

2. The lighting assembly of claim 1, wherein the at least one light source is plurality of LEDs arranged in an array along a length of the base.

3. The lighting assembly of claim 1, wherein the substrate is one or more of a nano-optic film or a lens comprising one or more of acrylic, polycarbonate or polymethylmethacrylate (PMMA).

4. The lighting assembly of claim 1, wherein the substrate is one or more of slid onto or disposed on the inside surface of the diffuser cover along the length of the diffuser cover from a first end to a second end, such that the substrate takes the shape of the diffuser cover.

5. The lighting assembly of claim 1, wherein the diffuser cover includes a pair of flanges and the substrate includes a first side and a second side, each of which is press fit between the flanges of the diffuser cover and a portion of the base.

6. The lighting assembly of claim 1, wherein upon contact with the substrate, each ray of light emitted from the at least one light source is disposed at an angle θ₂ greater than an acute angle θ₁ at which the light is first emitted from the at least one light source before contacting the substrate.

7. The lighting assembly of claim 1, wherein an angle at which at least one ray of light is emitted from the at least one light source changes from an acute angle to an obtuse angle from the longitudinal axis of the at least one light source upon contact with the substrate, allowing light to be directed upwardly from a center point of the lighting assembly.

8. The lighting assembly of claim 1, wherein an angle at which the light is emitted from the at least one light source increases for each at least one ray of light upon contact with the substrate, allowing light to be directed downwardly, upwardly and laterally from a center point of the lighting assembly.

9. A lighting assembly comprising:
a base having a pair of sides;
at least one light source coupled to the base and having a longitudinal axis, wherein the at least one light source is adapted to illuminate;
a diffuser cover removably secured to the base and having an inside surface and an outside surface; and
a substrate attached to the base and having an inner surface and an outer surface, the substrate forming a first volume between the inner surface of the substrate and the base and a second volume between the outer surface of the substrate and the diffuser cover, wherein the at least one light source is disposed within the first volume such that at least one ray of light emitted from the at least one light source contacts the substrate;
the diffusion of at least one ray of light emitted from the at least one light source is first increased upon contact with the inner surface of the substrate and again increased upon contact with the diffuser cover, creating a wider distribution of light around the outside surface of the diffuser cover and reducing glare.

10. The lighting assembly of claim 9, wherein the substrate is one or more of a nano-optic film or a lens comprising one or more of acrylic, polycarbonate or polymethylmethacrylate (PMMA).

11. The lighting assembly of claim 9, wherein the base includes a board and the substrate includes a first side and a second side, and each of the first and second sides of the substrate are press-fit between the board and another portion of the base.

12. The lighting assembly of claim 9, wherein the substrate is suspended from the base between the base and the diffuser cover.

13. The lighting assembly of claim 9, wherein upon contact with the inner surface of the substrate, each ray of light emitted from the at least one light source is disposed at an angle θ₂ from the longitudinal axis of the at least one light source that is greater than an acute angle θ₁ at which the light is emitted before contacting the inner surface of the substrate.

14. The lighting assembly of claim 13, wherein upon contact with the inside surface of the diffuser cover, at least one ray of light is disposed at an angle θ₃ from the longitudinal axis of the at least one light source that is greater than the angle θ₂ at which the at least one ray of light contacts the inner surface of the substrate, allowing light to be directed upwardly from a center point of the lighting assembly.

15. The lighting assembly of claim 9, wherein an angle at which the light is emitted from the at least one light source increases for at least one ray of light upon contact with the inner surface of the substrate and again upon contact with the inside surface of the diffuser cover, allowing light to be directed downwardly, upwardly and laterally from a center point of the lighting assembly.

16. A method of diffusing light emitted from a lighting assembly, the method comprising:
removably securing a diffuser cover to a base having at least one light source coupled thereto, the diffuser cover having an inside surface and an outside surface;
attaching a substrate to one or more of the base or the inside surface of the diffuser cover, the substrate comprising one or more of a nano-optic film or a lens material comprising one or more of acrylic, polycarbonate or polymethylmethacrylate (PMMA); and
directing at least one ray of light emitted from the at least one light source into contact with the substrate, causing light from the at least one light source to be widely distributed about the outside surface of the diffuser cover.

17. The method of claim 16, wherein directing the at least one ray of light emitted from the at least one source of light into contact with the substrate further comprises directing the at least one ray of light first into contact with the inner surface of the substrate and then into contact with the inside surface of the diffuser cover, increasing diffusion upon contact with each surface.

18. The method of claim 16, wherein attaching a substrate to one or more of the base or the inside surface of the diffuser cover comprises attaching a first side of the substrate to a first side of the base and a second side of the substrate to a second side of the base and between the base and the diffuser cover, such that the substrate is suspended between the base and the diffuser cover.

19. The method of claim 16, wherein attaching a substrate to one or more of the base or the inside surface of the diffuser cover comprises one or more of sliding a substrate onto the inside surface of the diffuser cover or press-fitting the substrate between the base and the diffuser cover.

20. The method of claim 16, wherein attaching a substrate to one or more of the base or the inside surface of the diffuser cover comprises attaching the substrate to the inside surface of the diffuser cover via an adhesive or the like.
